(19) United States
(12) Patent Application Publication
(10) Pub. No.: US 2024/0072332 A1
(43) Pub. Date: Feb. 29, 2024

(54) Plug-in Connection Element for a Cooler of a High-Voltage Accumulator

(71) Applicant: Bayerische Motoren Werke Aktiengesellschaft, Muenchen (DE)

(72) Inventors: Dominic MUELLER, Buxheim (DE); Markus STOLL, Muenchen (DE)

(21) Appl. No.: 18/280,294

(22) PCT Filed: Apr. 6, 2022
(86) PCT No.: PCT/EP2022/059095

§ 371 Date: Sep. 5, 2023

(30) Foreign Application Priority Data
May 5, 2021 (DE) 10 2021 111 663.5

(51) Int. Cl. H01M 10/6567; H01M 10/613

(52) U.S. Cl. CPC H01M 10/6567; H01M 10/613

(57) ABSTRACT

The present subject matter relates to a connection element for a cooler of a high-voltage accumulator. A coolant supply system extends between a supply interface and a discharge interface. A connection interface connects a heat exchange element of the cooler to the coolant supply system. The supply interface and the discharge interface have congruent interface contours. A cooler element and a cooler for a high-voltage accumulator are also provided.

### BACKGROUND AND SUMMARY OF THE INVENTION

The present subject matter relates to a connection element for a cooler of a high-voltage accumulator, a cooler element having such a connection element and a cooler having at least two such cooler elements.

The present subject matter is described in this instance for use in an intermediate cell cooler for battery cells within a high-voltage accumulator which has a large number of round cells which are arranged in several rows between which a cooler element is inserted. Since the present subject matter primarily relates to the connection of the individual cooler elements to the coolant system, the present subject matter can of course also be used independently of this application context.

In intermediate cell coolers, a supply of the cooling profiles may be achieved a common rail which is assembled and formed by directly opening with a mandrel the alternately arranged, separately formed pipe pieces and connection elements with interface contours which are formed in a male manner at both sides.

This “opening with a mandrel” solution has a high structural spatial requirement, in particular axially with regard to a longitudinal axis of the extent of the common rail. In addition, the construction type involves additional costs with the additional pipe pieces, a high number of sealing locations as a result of additional separation locations/components and consequently many possibilities for assembly errors or leakages. The solution of opening with a mandrel further does not enable any simple disassembly for subsequent work if a sealing test after assembly reveals a leak.

Against this background, an object of the present subject matter is to improve a cooler for a high-voltage accumulator.

Each of the independent claims determines with the features thereof subject-matter which achieves this objective. The dependent claims relate to advantageous further developments of the present subject matter.

According to one aspect, there is disclosed a connection element for a cooler, in particular an intermediate cell cooler, of a high-voltage accumulator which in particular has a large number of energy storage cells which are arranged in at least two rows and which in particular is provided in a motor vehicle. The connection element has at least:
(a) one coolant collection line having a coolant guide which extends between a supply line interface and a discharge line interface for coolant,
(b) one connection interface for connecting, in particular a cooling path, a heat exchange element of the cooler to the coolant guide, in particular with regard to a coolant exchange, wherein the connection interface is arranged on the coolant guide in particular between the supply line interface and the discharge line interface.

In this instance, the supply line interface and the discharge line interface have interface contours which are congruent, in particular with respect to each other.

It is thereby possible for a plurality of identically configured connection elements to be inserted into each other. With appropriate sealing of the supply and discharge line interfaces, the coolant guide between adjacent connection elements may consequently be achieved in a manner which is tight with respect to coolant, without connection components, such as, for example, pipe pieces which are required with the known opening with a mandrel of known connection elements.

A typical intermediate cell cooler requires a large number of cooling elements and consequently connection elements; the number corresponds to at least approximately half the cell row number when as with intermediate cell coolers, each cell row is cooled at one side. The present subject matter therefore saves a large number of connection components which are intended to be assembled (together, therefore in a complex manner) and consequently enables a much simpler, less error-prone assembly.

Furthermore, a more compact construction type and/or arrangement of the adjacent connection elements is possible since, firstly, only one of the supply line interface and the discharge line interface is constructed to protrude and, secondly, the separate connection elements are omitted.

This enables—in particular with round cell high-voltage accumulators with cell types which are typically used, such as, for example, 18650—a construction of intermediate cell coolers which cool at two sides, as provided according to an example with one heat exchange element in each case and consequently one connection element, at least in regions, between all the cell rows.

The term “congruent interface contours” is intended to be understood in this instance in particular to mean that one of the two interfaces has the interface contour as an inner contour, and the other of the two interfaces has it as an outer contour. In this instance, deviations of the two congruent interface contours from each other are particularly possible in that a sealing action of a connection of the two interfaces with adjacent connection elements which are identically constructed according to the present subject matter with regard to the coolant collection line is not impaired through both connection elements involved. The term “deviations” in this instance is intended to be understood in particular to mean tolerance deviations and/or measurements which enable an insertion of one in the other without impairing a sealing action. However, more extensive deviations may also be intended, for example, a provision of a remaining recess between the congruent interface contours according to the present subject matter after being inserted one into the other.

According to one example, one of the supply line interface and the discharge line interface is in the form of a male plug-in element and the other of the supply line interface and the discharge line interface is in the form of a female plug-in element.

According to one example, an adequate sealing action is ensured using a circumferential seal, in particular one or more sealing rings, on one or both interfaces. Alternatively, the material of the connection element may also be selected in an appropriate manner in order with appropriate assembly to form a reliable, circumferential sealing contact between two connection elements, in particular as a result of a suitable resilience.

According to another aspect, there is disclosed a cooler element for a cooler, in particular an intermediate cell cooler, a high-voltage accumulator, in particular in a motor vehicle, having at least one connection element according to an example of the present subject matter, and a heat exchange element having a cooling path which is arranged using a cooling path interface on the connection interface of a coolant guide of the connection element.

According to another aspect, an intermediate cell cooler for a high-voltage accumulator is disclosed, in particular in a motor vehicle, having at least two cooler elements according to an example of the present subject matter, wherein the cooler elements at the supply line interface(s) of a cooling element are connected to the discharge line interface(s) of the adjacent cooling element in order to guide coolant, in particular when inserted and/or joined in a coolant-tight manner (for example, using soldering or welding or the like).

In particular, the intermediate cell cooler has a plurality of cooler elements, for example, one in all the intermediate spaces between two cell rows of the high-voltage accumulator, respectively, which are arranged beside each other along a longitudinal axis and which form the coolant guide(s) along the coolant collection lines which are inserted into each other. In particular, the coolant guide(s) then form(s) (where applicable separately if in the connection elements a plurality of, in particular two, coolant collection lines, for example, for a coolant supply line and a coolant discharge line, are provided) a common rail with respect to the coolant, which is intended to be supplied or discharged, of the individual heat exchange element.

The heat exchange elements are each in the form, for example, of a cooling plate or undulating cooling profile and/or are each constructed for arrangement between two cell rows of the high-voltage accumulator. For example, the heat exchange elements may each, at least partially, be subsequently formed and/or formed on cell covers of the accumulator cells between which they are arranged.

In particular, a plastics material or a metal material (such as, for example, an aluminum alloy) which is suitable for directing the coolant used, for example, cooling water or a cooling oil, in a reliable manner in the intended temperature range may be considered as a material of the connection element. In particular, the connection element is produced using a plastics material injection-molding or aluminum die-casting method. In particular, there is provided circumferentially, radially externally on the male interface contour(s) at least one circumferential seal (in particular in the form of an O-ring), for example, made from a suitable rubber, silicone or polymer material.

A hollow profile may in particular be considered as a heat exchange element, in particular made of an aluminum alloy which is suitable for directing the coolant used, for example, cooling water or a cooling oil, in a reliable manner in the intended temperature range. For example, the hollow profile is produced using an extrusion method and/or has, for example, an injected electrical insulation layer made of a dielectric polymer material.

When the heat exchange element and the connection element are each produced from a metal material, for example, an aluminum alloy, the connection can be soldered or welded in a coolant-tight manner. If one of the heat exchange element and the connection element is produced from a plastics material and the other from a metal material, or both are produced from a plastics material, the connection can be adhesively bonded in a coolant-tight manner.

The present subject matter is based inter alia on the notion of configuring the connection elements in such a manner that they can be stacked directly one inside the other. No other connection element is required, in particular no separate one. In particular, there is thus brought about an integration of the common rail in the connection elements of the individual heat exchange elements.

When with the stacked connection elements both a supply line common rail for cool coolant and a discharge line common rail for warm coolant is provided, each of the connection elements which are intended to be stacked one inside the other has two male extension pieces with a radially external interface contour and two female connections with a congruent, radially internal interface contour. The male extension pieces of the first connection element engage in the female connections of the next connection element and consequently form a warm and a cool common rail. The connection interfaces for the heat exchange elements are arranged between the male and female connections and are in particular in the form of cooling plates and/or profiles.

The sealing between the male and female connections is, for example, ensured using O-rings.

In order to keep the tolerances between the two interface contours (outgoing flow and return flow) small, according to one example both interface contours are produced from one piece. With suitable tolerance compensation measures, according to an alternative example a multiple-piece solution may also be provided.

In order to enable a good distribution of the coolant through the common rail(s), according to one example the flow cross-section of the common rail is intended to be configured to be significantly larger than the one individual heat exchange element.

According to a further development of the present subject matter, a subsequent processing/repair solution is enabled by an additional groove being provided in the male extension piece and a transverse hole in the female connection at the same axial position (in the assembled state). As a result of the transverse hole, in the event of a malfunction, sealing medium can be introduced into the groove in order to ensure the sealing, for example, when the O-ring is damaged.

Alternatively, to the groove in the male extension piece, such a subsequent processing operation is possible when a transverse hole is provided when the otherwise congruent interface contours deviate from each other in the axial region of the transverse hole in such a manner that during the assembly a circumferential recess which can be filled with sealing mass remains.

According to one example, the connection element has a first side wall, from which one from the supply line interface and the discharge line interface extends away from the connection interface, and a second side wall, from which the other of the supply line interface and the discharge line interface extends toward the connection interface, wherein according to one example the two side walls are constructed, with connection elements which are inserted one in the other, that is to say, assembled, and which are constructed in accordance with the present subject matter and in the same manner, to abut each other. A stacking of the connection elements and consequently also of the cooler elements which is tight to the maximum extent in a longitudinally axial manner can thereby be achieved.

According to one example, the first and second side walls are constructed in such a manner that, when two connection elements which are constructed according to the present subject matter and in an identical manner are inserted one into the other, they together form a stop at and/or from which the seal, in particular as a result of the supply line interface and the discharge line interface being inserted one in the other, is reliably formed. A simple optical, acoustic and/or haptic check of the correct assembly can thereby easily be carried out. Furthermore, an axially tight stacking of the connection elements and consequently also of the cooler elements is further optimized.

According to one example, the congruent interface contours are constructed in such a manner that, when a connection is constructed, a circumferential hollow space, in particular a recess and/or groove, remains between the two interface contours. This hollow space may in the event of a negative sealing check be filled with a sealing mass without disassembly of the already assembled cooler elements and may thus subsequently and reliably seal the connection.

According to one example, on the interface which is constructed in a receiving manner, in particular in the form of a female plug-in element, a continuous recess extends from an outer surface toward a portion of the interface contour on which the circumferential hollow space is formed during a connection. Consequently, it is simple if necessary to fill the hollow space with an in particular fluid and/or curable sealing mass—even in the assembled state of the cooler elements.

According to one example, the connection element has two coolant collection lines which are separated from each other and of which one is in the form of a (cool) coolant supply line and one is in the form of a (warm) coolant discharge line. For each heat exchange element, a single connection element is thereby sufficient. The assembly is thereby significantly simplified by the number and the complexity of the joining operations when the cooler elements are assembled on the integral connection elements decreasing as a result of the congruent interfaces.

According to one example, there is arranged on the coolant supply line an outlet connection interface for connecting a cool side, in particular of a cooling path, of a heat exchange element, and on the coolant discharge line an inlet connection interface for connecting a warm side, in particular of a cooling path, of the heat exchange element. Consequently, a cooler element comprising a single connection element and a single heat exchange element can be formed and a plurality of such identical cooler elements can be assembled to form an intermediate cell cooler.

### BRIEF DESCRIPTION OF THE DRAWINGS

FIG. 1 shows a cut-out of an intermediate cell cooler having a plurality of connection elements which are inserted one into the other according to an example of the present subject matter,

FIG. 2 shows the cut-out of the intermediate cell cooler from FIG. 1 with sectioned fluid guides in the connection elements,

FIG. 3 shows by way of example a cut-out of one of the cooler elements of the intermediate cell cooler from FIG. 1 in an oblique view of the radially external interface contours,

FIG. 4 shows by way of example a cut-out of one of the cooler elements of the intermediate cell cooler from FIG. 1 in an oblique view of the radially internal interface contours,

FIG. 5 shows the cut-out of FIG. 3 with an associated coolant diverter which is in the form in the example of a diversion pipe.

### DETAILED DESCRIPTION

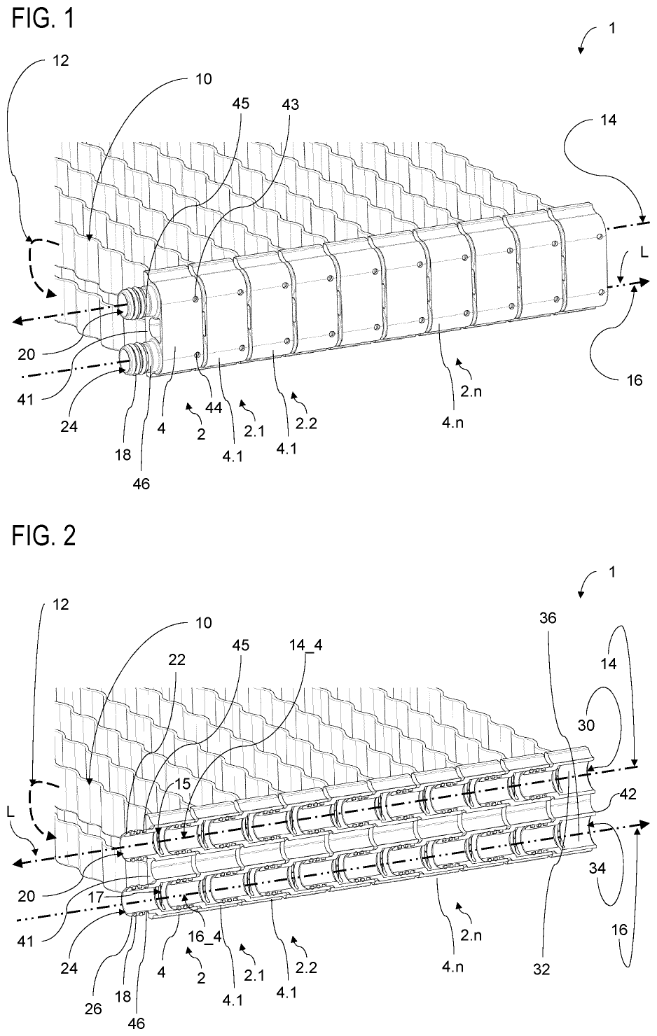

FIG. 1 shows a cut-out of a cooler 1 which is in the form of an intermediate cell cooler for a high-voltage accumulator (otherwise not illustrated) of a motor vehicle.

The cooler 1 has a plurality of cooler elements 2 which are all constructed in an identical manner at least with respect to the connection elements 4 thereof and which are, along a longitudinal axis L of the coolant guides 14 and 16 which form them, fitted one on the other in a coolant-tight manner (sealing in each case using two circumferential seals 18, in this instance O-rings). The connection elements 4 thus form a supply line common rail (cool coolant guide 14) and a discharge line common rail (warm coolant guide 16).

The path of the two common rails 14 and 16 can be derived in the same manner as the positions of the circumferential seals 18 from the sectioned view in FIG. 2.

Each of the cooler elements 2 has precisely one connection element 4 and precisely one hot plate as a heat exchange element 10 having a cooling path 12 which is arranged using cooling path interfaces on a supply line interface 15 of the cool coolant guide 14 and on a discharge line connection interface 17 of the cool coolant guide 14 of the respective connection element 4.

The cell rows of the cooler 1 are not illustrated in the figures. A cell row which is intended to be cooled is arranged between two adjacent heat exchange elements 10 so that each row is cooled at both sides on the covering faces of the cells. For an improved cooling, each heat exchange element 10 is formed in an undulating manner on the covering faces of the individual cells so that adjacent cell rows are arranged with spacing of the longitudinal center axes thereof from the respective connection element in a state slightly offset with respect to each other.

The connection elements 4 are produced using an aluminum die-casting method. The heat exchange elements 10 are configured with extruded aluminum hollow profiles which are provided with a sprayed-on dielectric. At a redirection region which is not illustrated, the heat exchange elements 10 are either bent over or they comprise two hollow profiles between which in the redirection region a pipeline for coolant redirection is arranged. The connection interfaces 15 and 17 are soldered with the cooling path interfaces or professionally connected in a coolant-tight manner in another appropriate manner in order to reliably ensure the coolant transition into and out of the cooling path 12.

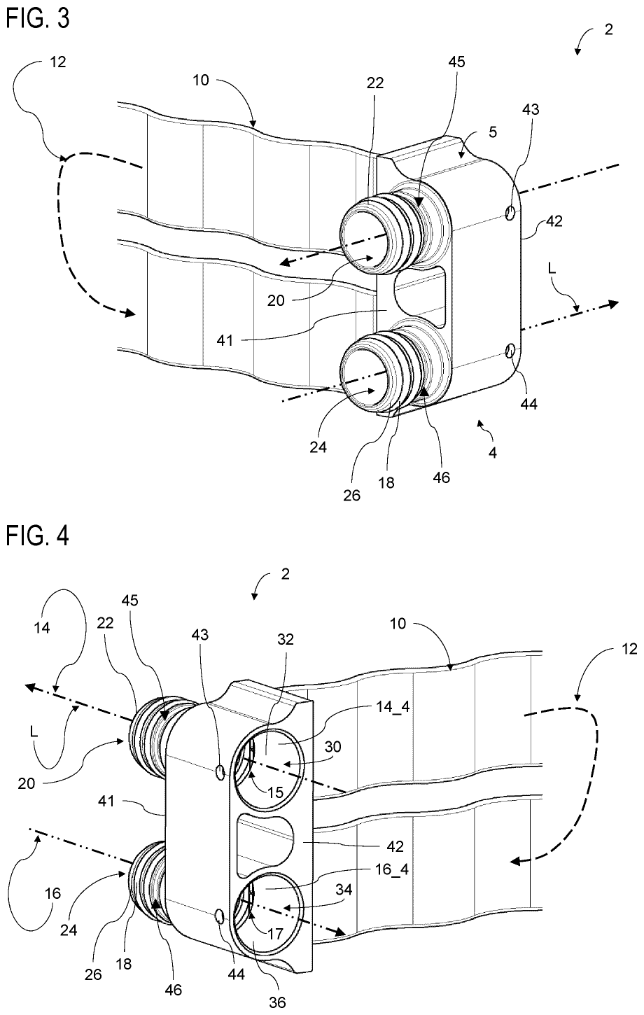

FIGS. 3 and 4 show by way of example a cut-out of one of the cooler elements 2 of the cooler 1 from FIG. 1 as two different oblique views. The view of FIG. 3 is directed toward the radially external interface contours 22, 26 (male plug-in partners 20, 24) of the two common rails 14 and 16, the view of FIG. 4 is directed toward the radially internal interface contours 32, 36 (female plug-in partners 30, 34) of the two common rails 14 and 16.

For the cool common rail 14, the cool coolant flow (dash/dot line) is directed along the longitudinal axis L in each connection element 4 from the female plug-in partner 30 toward the male plug-in partner 20 so that the female plug-in partner forms the cool supply line interface 30, the male plug-in partner forms the cool discharge line interface 20.

For the warm common rail 16, the coolant flow (dash/double dot line) is directed along the longitudinal axis L in each connection element 4 from the male plug-in partner 24 toward the female plug-in partner 34 so that the male plug-in partner forms the warm supply line interface 24 and the female plug-in partner forms the warm discharge line interface 34.

Each of the identically constructed connection elements 4 has in the example an aluminum member 5 having two coolant collection lines 14_4 and 16_4 on which in each case the connection interface 15 or 17 is arranged between the supply line interface 30 or 24 and the discharge line interface 20 or 34 (cf. FIG. 4), respectively.

The interfaces 20 and 24 which are constructed in a male manner each have a radially external circumferential contour 22 or 26 which is constructed to be congruent at least with respect to the radially internal interface contour 32 or 36 of the interfaces 30 and 34 which are constructed in a female manner.

It is thereby possible for a plurality of identically configured connection elements to be inserted one into the other. The coolant guide between adjacent connection elements can consequently be achieved with an appropriate sealing of the supply and discharge line interfaces which are inserted one in the other in a coolant-tight manner without connection components, such as, for example, pipe pieces which are required with the known opening of known connection elements using a mandrel.

In the example, both male interfaces 20 and 24 are even constructed identically, and consequently also the corresponding female interfaces 30 and 34, in order to configure the connection elements in an even simpler manner.

The exemplary cooler 1 can consequently be constructed to be axially so tight that a dual-sided cooling of the covering faces of the round cell rows is enabled.

When the cooler 1 is mounted, a first side wall 41 of the connection element 4 and a second side wall 42 of the adjacent connection element abut each other and together form a stop in which the sealing is reliably formed using the O-rings 18. A simple optical examination of the correct assembly can thereby take place. Furthermore, an axially tight stacking of the connection elements and consequently also of the cooler elements is optimized.

There is arranged on each female interface 32, 36 a continuous recess 43 or 44 (either already from the injection-molding mold or in the form of a hole) through which, if necessary for subsequently processing a defective O-ring seal, a sealing mass can be injected into a circumferential hollow space 45 or 46 which, when it strikes adjacent connection elements 4, remains between the two otherwise congruent interface contours 22 and 32 or 26 and 36.

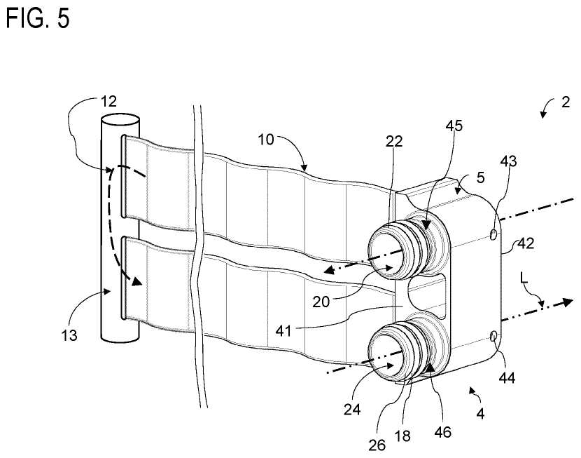

FIG. 5 shows the cut-out of a cooler element 2 as illustrated in FIG. 3 and in addition an associated coolant diverter 13 which in the example is in the form of a diversion pipe. The diversion pipe 13 borders, for example, a cylindrical hollow space and has an upper coolant supply line interface at which coolant from the upper portion of the heat exchange element 10 is received, and a lower coolant supply line interface at which coolant is discharged at the lower portion of the heat exchange element 10. The heat exchange element 10 is not illustrated in its entire length; this is indicated in the illustration by the vertical double separation line.

### LIST OF REFERENCE NUMERALS

1 Cooler
2 Cooler elements
4 Connection elements
5 Aluminum member
Heat exchange element
12 Cooling path
13 Coolant diverter, in this instance a diversion pipe
14 Cool coolant guide (cool common rail)
14-4 Cool coolant collection line
Cool connection interface
16 Warm coolant guide (warm common rail)
16_4 Cool coolant collection line
17 Warm connection interface
18 Circumferential seals
Cool discharge line interface
22, 26 Radially external interface contours
24 Warm supply line interface
30 Cool supply line interface
32, 36 Radially internal interface contours
34 Warm discharge line interface
41, 42 Side walls
43, 44 Continuous recess
45, 46 Circumferential hollow space
L Longitudinal axis

1.-11. (canceled)

12. A connection element for a cooler of a high-voltage accumulator, comprising:
a coolant guide that extends between a supply line interface and a discharge line interface; and
a connection interface configured to connect a heat exchange element of the cooler to the coolant guide, wherein
the supply line interface and the discharge line interface have congruent interface contours.

13. The connection element according to claim 12, wherein
one of the supply line interface and the discharge line interface is in the form of a male plug-in element and the other is in the form of a female plug-in element.

14. The connection element according to claim 12, further comprising:
a first side wall from which one from the supply line interface and the discharge line interface extend away from the connection interface; and
a second side wall from which the other of the supply line interface and the discharge line interface extends toward the connection interface, wherein
the two side walls are constructed to this end.

15. The connection element according to claim 14, wherein
the first side wall and the second side wall are constructed such that they abut each other when the connection elements are inserted one into the other.

16. The connection element according to claim 14, wherein
the first side wall and the second side wall are constructed such that when two connection elements are inserted one into the other, a stop and seal are formed.

17. The connection element according to claim 12, wherein
the congruent interface contours are constructed such that when a connection is constructed, a circumferential hollow space remains between the two interface contours.

18. The connection element according to claim 17, wherein
on the interface, which is constructed in a receiving manner, a continuous recess extends from an outer surface toward a portion of the interface contour on which the circumferential hollow space is formed during a connection.

19. The connection element according to claim 12, further comprising:
two coolant collection lines separated from each other and in which one coolant collection line is in the form of a coolant supply line and the other coolant collection line is in the form of a coolant discharge line.

20. The connection element according to claim 19, further comprising:
an outlet connection interface disposed on the coolant supply line, which is configured to connect a cool side of a heat exchange element; and
an inlet connection interface disposed on the coolant discharge line, which is configured to connect a warm side of the heat exchange element.

21. A cooler element for a cooler of a high-voltage accumulator, comprising:
the connection element of claim 12; and
a heat exchange element comprising a cooling path connected via a cooling path interface to the connection interface of a coolant guide of the connection element in a coolant-tight manner.

22. A cooler for a high-voltage accumulator, comprising:
a plurality of cooler elements according to claim 21, wherein
the cooler elements at the supply line interface(s) of a cooler element are connected to the discharge line interface(s) of the adjacent cooler element to guide coolant when the cooler elements are inserted into done another.
